(19) United States
(12) Patent Application Publication
(10) Pub. No.: US 2018/0322411 A1
(43) Pub. Date: Nov. 8, 2018

(54) AUTOMATIC EVALUATION AND VALIDATION OF TEXT MINING ALGORITHMS

(71) Applicant: LinkedIn Corporation, Sunnyvale, CA (US)

(72) Inventors: Hu Wang, Mountain View, CA (US); Chi-Yi Kuan, Fremont, CA (US); Yongzheng Zhang, San Jose, CA (US); Rui Zhao, Mountain View, CA (US)

(21) Appl. No.: 15/586,739

(22) Filed: May 4, 2017

(51) Int. Cl. G06N 99/00; G06F 17/30; G06N 7/00

(52) U.S. Cl. CPC G06N 99/005; G06N 7/005; G06F 17/30705

(57) ABSTRACT

In some embodiments, the disclosed subject matter involves comparing the results of natural language processing (NLP) of unstructured text to historical results for verification and validation of the NLP models/algorithms. The analysis uses statistical theory and practices to automatically monitor and validate the performances of the (NLP) algorithms on a periodic basis. Each unstructured text is run through one or more NLP algorithms and scored for relevance or contextual classification. Distribution of the scores is assumed to be Gaussian in nature so that a probability value (p-value) may be generated. When the p-value is below a threshold value, manual tagging may be initiated for the current time period to help retrain the models for better performance. Other embodiments are described and claimed.

### TECHNICAL FIELD

An embodiment of the present subject matter relates generally to automated methods for validating confidence levels of data, and, more specifically, but without limitation, to using a trained model to generate confidence values and provide results in a visual bar chart indicating whether confidence levels fall within a range of acceptable levels.

### BACKGROUND

Various mechanisms exist for categorizing data for analytics and data mining. Analytics may be used to discover trends, patterns, relationships, and/or other features related to large sets of complex data. Text analytics may provide access to member feedback about a product or product family to developers or management of a corporation, organization or enterprise. Text analytics systems may use Natural Language Processing (NLP) algorithms to identify relevant conversations or text portions through word and content identification and contextual classification. The information deemed relevant may be used to gain insights and/or guide decisions and/or actions related to the product. For example, business analytics may be used to assess past performance, guide business planning, and/or identify actions that may improve future performance.

The analytics, however, are only as good as the relevance and classification models. Thus, the results of analytics should be frequently verified to validate the accuracy of the models and/or training data. Existing systems may typically use a series of time intensive, and cumbersome manual tagging to analyze the results of the NLP algorithms.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a system for identifying relevance in unstructured text, according to an embodiment;

FIG. 2 is a flow diagram illustrating a computer implemented method for validating relevance models, according to an embodiment;

FIG. 3 is a flow diagram illustrating a method for scoring the verbatims, according to an embodiment;

FIG. 4A illustrates data for Week 51 for company level score bins, according to an embodiment;

FIG. 4B illustrates data for Week 52 for company level score bins, according to an embodiment;

FIGS. 5A-B illustrate two weeks of data for sentiment neutral scoring, according to an embodiment:

FIGS. 6A-B illustrate two weeks of data for sentiment positive scoring, according to an embodiment;

FIGS. 7A-B illustrate two weeks of data for sentiment negative scoring, according to an embodiment;

FIGS. 8A-B illustrate two weeks of data for scoring of defined Topic1, according to an embodiment; and

FIG. 9 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to a methodology, based on statistical theory and practices, to automatically monitor and validate the performances of natural language processing (NLP) algorithms on a periodic basis. In an embodiment, the NLP is used to determine relevance and contextual classification of unstructured textual data.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Prior attempts to validate the accuracy of NLP models required several hours of manually tagging 100 or more verbatims, or text items, for each new data set. Embodiments described herein provide a statistical methodology to validate algorithm performances using an automated system. An interpreted language, such as the Python programming language, may be used to develop scripts to automate the validation process. An embodiment may provide a more objective validation computation than for manual tagging. Traditionally, manually tagging samples, may have been subjective, and the results may vary person by person. Thus, using an automated process provides more objective and repeatable results by avoiding human interactions. Additionally, validation methods as described herein may easily scale to NLP model classification algorithms in other domains.

For instance, in an embodiment, a relevance algorithm may be used to determine the relevancy of social mentions by learning context of the verbatim (e.g. text portion such as a tweet, email, on-line bulletin board post, etc.). In an example, the results of the relevance algorithm may provide a relevance score ranging from 0 to 1, where 0 means not relevant at all, and 1 means extremely relevant. Each verbatim may be passed through the relevance algorithm and given a score. The relevance algorithm ensures that the verbatims are tagged with relevance or contextual classifications that are relevant to the desired analyses.

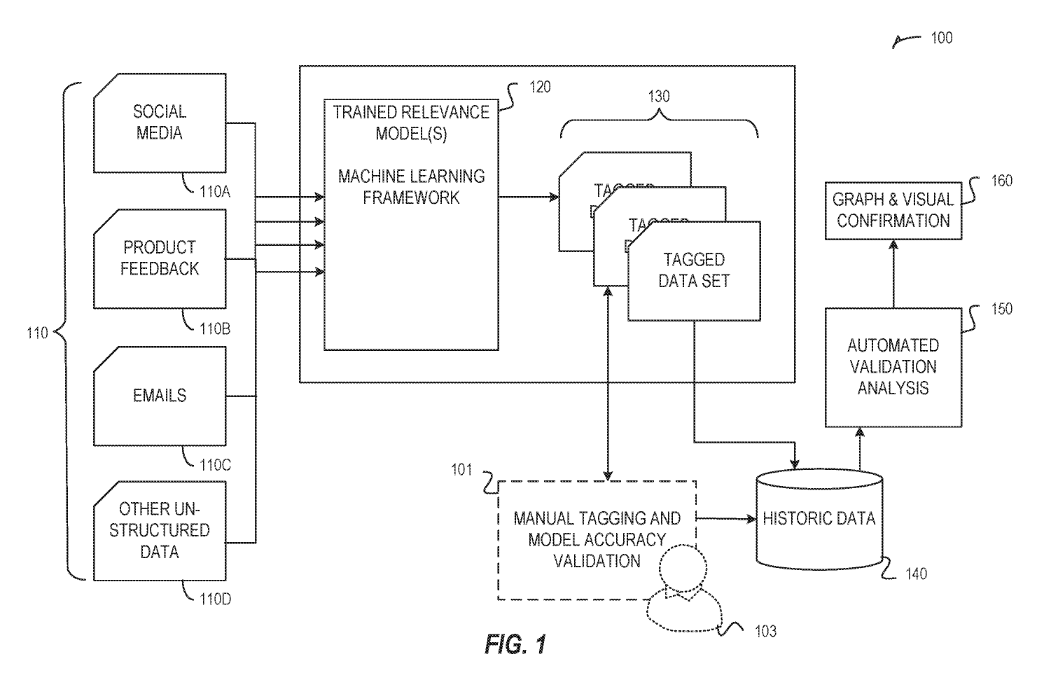

FIG. 1 is a block diagram illustrating a system 100 for identifying relevance in unstructured text (also referred to herein as “verbatims”) 110, according to an embodiment. A variety of sources may be used for collection of verbatims. In an example, unstructured text 110 may be retrieved from sources including social media (e.g., Facebook®, Twitter®, LinkedIn®) 110A; product feedback (e.g., electronic bulletin boards, user groups, listservs, discussion boards) 110B; emails 110C; and other sources 110D. The verbatims may be sent to trained relevance models 120 as unstructured text. In the era of big data, corporations and businesses are increasingly collecting immense amounts of unstructured data in the form of free text, from sources such as customer service conversations to market research surveys. It is clear that such member feedback, or “Voice of the Member” (VOM), contains valuable information. However, it may be less clear how to best analyze such data at scale. In an example, a text analytics platform such as Voices used internally by LinkedIn®, may be used to collect and analyze unstructured text from licensed or public sources.

A machine learning framework 120 may be used to build text classification models. In an embodiment, a machine learning framework 120 may include one or more text classification models. In an example system, models may be used to classify relevance, perform sentiment analysis, and identify value propositions. In the Voices example, a relevance model may identify whether a piece of text is relevant to LinkedIn® (the brand and various products). Sentiment analysis may identify the sentiment polarity of a piece of text as positive, neutral, or negative. A value proposition may identify whether a piece of text belongs to one of key LinkedIn®@ value propositions, e.g. Hire, Market, Sell, Connect, or Get Hired. In other words, a value proposition may be a category to identify conversations to further the values of the corporation or its customers. For example, LinkedIn may have a corporate value proposition to help members:
stay connected with their professional network,
get informed,
build their network,
advance their career,
work smarter,
find/generate leads, and
get clients.

A general description of relevance and content based classification models that may be used can also be found in the engineering blog: engineering*linkedin*com/blog/2016/06/voices—a-text-analytics-platform-for-understanding-member-feedb, where the periods have been replaced with asterisks in the URL to avoid an unintentional hyperlink. Some techniques may also be found in published patent applications 2017-0076225 A1 entitled, “Model-Based Classification Of Content Items” and 2017-0075978 A1 entitled, “Model-Based Identification Of Relevant Content.” It will be understood that a variety of trained relevance or content classification models may be used, based on the unstructured data available, and what the analysts are attempting to discern from the data. The trained models receive or retrieve the unstructured texts and tag them with determined classifications.

Once analyzed for relevance and classification tagged in block 120, the structured data may be formed into sets 130, based on relevance or classification factors. In an example, one set of data may be relevant to product A, and a second set of data may be relevant to product B. In another example, all of the tagged data may reside in a single data set. In previous systems, an analyst 103 performed the cumbersome task of manual tagging and validation of accuracy 101 for the models in block 120. In an embodiment, the tagged data set(s) 130 may be stored in an historical data database 140. An automated validation logic, or module 150, may perform analysis on the historical data to determine whether a score for the data falls within a pre-defined margin or threshold. The analysis may be displayed as a graph on a display by graphing logic 160 to make it visually easy for an analyst to identify any unusual findings.

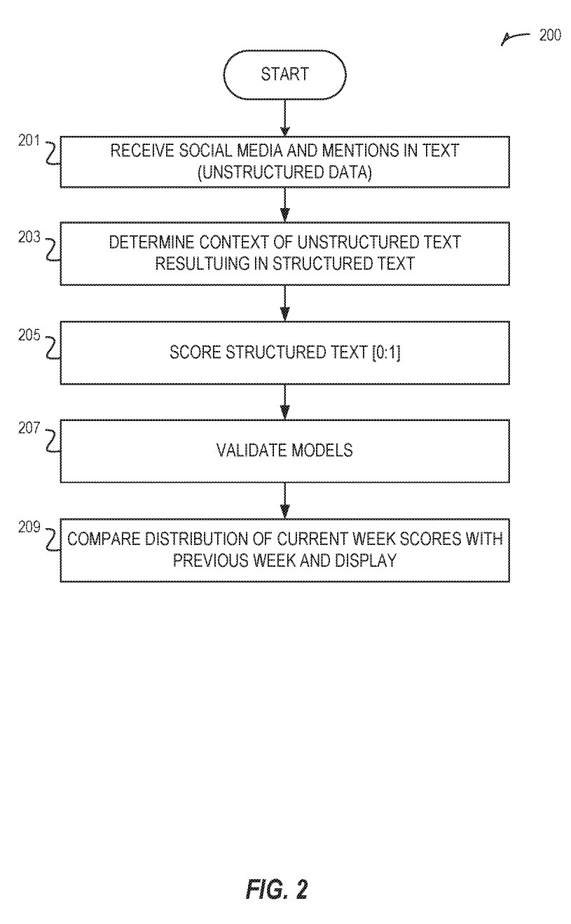

FIG. 2 is a flow diagram illustrating a computer implemented method 200 for validating a relevance model, according to an embodiment. The social media and/or other unstructured data (verbatims) may be received directly from the source(s), or retrieved from a data store where they were previously saved, in block 201. The context of the unstructured text may be determined with one or more relevance and context engines in block 203. In an example, a first relevance engine may be applied to a verbatim to determine whether the verbatim is relevant to a corporation or product of interest to a data analyst. If the verbatim is not relevant, it may be stored in a data store for future use. The irrelevant data may be stored with a “not relevant” tag, or remain unstructured (e.g., no tag). Once it has been determined that the verbatim is relevant at the top level (e.g., corporate or product level), other NLP algorithms may be applied to the verbatim to determine whether it is relevant to one or more topics. The topics of interest may be defined by a data analyst or analysis team, in advance, and may change over time. The verbatim may be tagged with a token or classification code indicating relevance to one or more of the pre-defined topics. The tagged verbatims may be stored in a data store for the structured or tagged data sets, for further analysis.

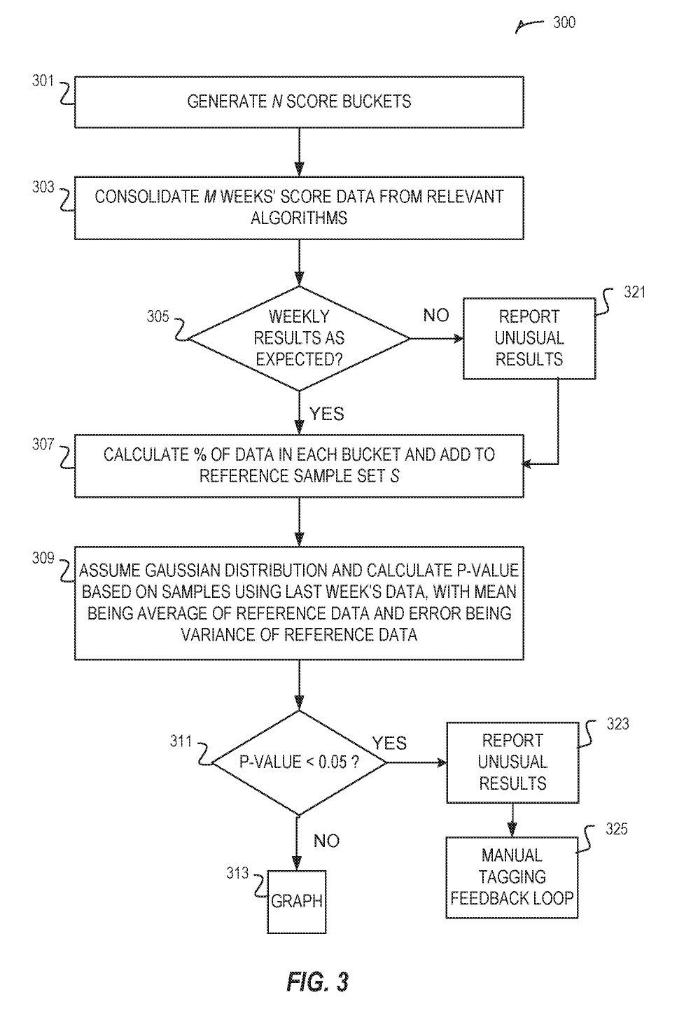

In an embodiment each verbatim may be scored and assigned to a bucket, or bin, in block 205. Referring to FIG. 3, a method for scoring the verbatims, according to an embodiment, is shown. Different NLP and relevance models may be used to identify whether the verbatim is relevant to a topic, or topic type. For instance, model may be used to determine relevance, product, value proposition, and sentiment. Each model may use one or more NLP algorithms to score a verbatim. Scored verbatims may be assigned to one of n buckets. The cumulative buckets may represent a range of probabilities between 0 and 1. In an example, scores for a model may be segmented into n=10 buckets, where each bucket encompasses 1/10 or 10%, e.g., 0.0-0.1, 0.1-0.2, 0.2-0.3, . . . , 0.9-1.0. Other models may use fewer or more than 10 buckets, as appropriate to distribute the results.

Once the data is scored and assigned to a bucket, the model(s) may be validated by statistically comparing with historic data in block 207 (FIG. 2). Referring again to FIG. 3, historic data for m weeks of data may be retrieved from an historical database and consolidated in block 303. In an embodiment, 30-50 weeks of data may be used. More or less data may be used, depending on the availability of historic data. In an embodiment, previously manually tagged verbatims may be used as initial historic data, for as many weeks as possible, to ensure accurate tagging. Verbatims may be tagged based on NLP models specific to the analysis task at hand. The consolidated data may include an average (e.g., mean) value for each bucket, as well as a confidence range for each bucket. For example, if 100 social mentions (verbatims) are collected in a week, and three mentions of them are given scores with range 0 to 0.1, then a numerical value 3% will be added into bucket 0.0-0.1. The values in the bucket indicate the frequency, or percent. This calculation is applied to other buckets for verbatims in the model. The distribution of data in each bucket may be compared and displayed to the user in graph form in block 209 for visual inspection and validation. Additional model validation methodology is described herein in conjunction with FIG. 3, below.

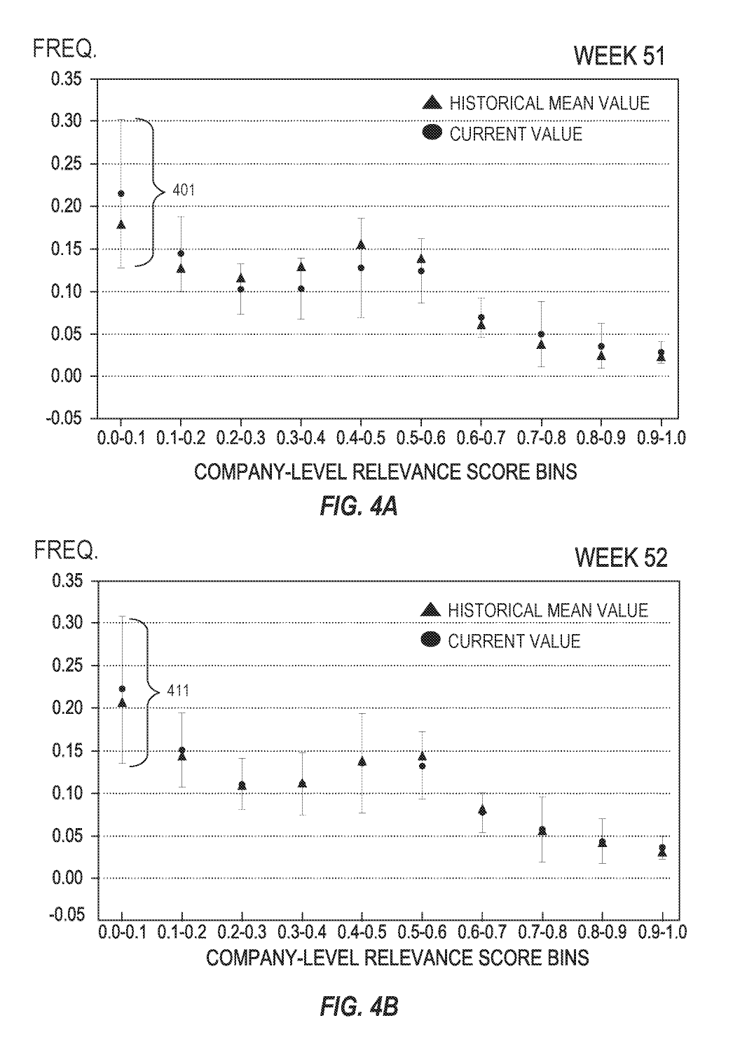

FIGS. 4A-B through 8A-B illustrate visual graphs showing a current week's data compared to consolidated historical data, according to an embodiment. It should be understood that the time period discussed herein is one week, but any convenient time period may be used, for instance, hourly, daily, weekly monthly, etc., based on the volume of data received. For example, FIG. 4A illustrates data for Week 51 for company level score bins (e.g., buckets). In this example, the 10 buckets are shown along the x-axis, ranging from 0.0 to 1.0. The y-axis indicates the percent of verbatims that fall within the collected data for the past weeks, e.g., historical data, for a given model. Vertical lines in the graph indicate a confidence range for data in each bucket. For instance, bucket (0.0-0.1) has confidence range 401 between approximately 0.125 to 0.3 frequency (e.g., 12.5 to 30%). It may be seen that the previous weeks' (historic data) mean value, as indicated with a solid triangle, and this week's current value as indicated with a solid circle, fall within the confidence range for bucket (0.0-0.1). FIG. 4B illustrates data for Week 52 for company level score bins. It can be easily seen that the confidence range at Week 52 for bucket (0.0-0.1) 411 is almost the same as the confidence range 401 at Week 51 (FIG. 4A). As data is scored and consolidated, confidence ranges may gradually move up or down, or expand and contract, over time.

Referring again to FIG. 3, once the model data is scored, consolidated and graphed, a data analyst may quickly view a graph such as illustrated in FIGS. 4A-B through 8A-B to determine whether the weekly results are as expected, in block 305. In an embodiment, the validation system may automatically judge the weekly data to be unusual (e.g., current week's data point outside of the confidence range), and send a notification to the user (e.g., data analyst) before (or after) rendering the graph for visual inspection. If the results show some anomaly, the results may be reported in block 321.

When the current week's data falls within normal ranges, the percentages of data within each bucket may be calculated, as generated in the scoring in block 301 and added to a reference sample set S. The reference sample set S may be considered as the NLP model results under normal/standard performance, and stored in a database as historical data, in block 307. For practical purposes, a Gaussian distribution of data may be assumed. A p-value, as understood with respect to the Central Limit Theorem and Normal Gaussian Distribution, may be calculated based on the samples using the historical data, where the mean is an average of reference data and the error is a variance of reference data, in block 309. If the p-value is less than a threshold, for instance, 0.05, as determined in block 311, it may statistically indicate that there is something unusual with the data, or model(s) for the current week, and actions need to be taken. It will be understood that a p-value is an industry term representing a calculated probability, where the probability is that of finding observed results when the null hypothesis of a study question is true. In other words, a small p-value (typically <0.05) indicates strong evidence against the null hypothesis. The p-value may be any number between 0 and 1. In this case, the null hypothesis is that the verbatims have been properly tagged and put into the proper buckets.

When the p-value indicates unusual results, the user may be notified in block 323. Depending on the results, the data analyst may decide to ignore the issue, perform further analysis, or select a subset of verbatims on which to perform manual tagging in block 325. In an embodiment, the automatic tagging of verbatims may tag all of the received unstructured text data. As a practical matter, manual tagging may be performed for a subset of verbatims. For example, for a given week, 100,000 verbatims may be received. Manual tagging may use 100-1000 randomly selected verbatims for model training and historical data, depending on the complexity of the data and the workforce available for tagging. Other percentages of the raw data may be manually tagged, in other examples. When unusual data is flagged by the p-value calculation, a sample of the verbatims for the period in question may be manually tagged and then provided to the NLP model training process to provide more accurate results. An advantage to performing manual tagging only when the confidence range is violated, or when a p-value is too small, rather than for all models every week, is the enormous amount of human time saved by not having to manually tag all of the data. Manually tagging data occasionally when the data strays from the norm, or when the model needs to be retrained may also improve the accuracy of the NLP models over time. In an embodiment, when the p-value is equal or above the threshold, the data may be rendered in a graph for visual inspection, or saved for later viewing/analysis, in block 312.

In an embodiment, retraining of the models (FIG. 1, 120) may be performed when the focus topic changes, or social media data skews the model. For example, if the enterprise launches a new product, for example, called PRODINABC, the model may need to be trained for the new product, e.g., to recognize the product name PRODINABC or identify contextual data corresponding to the new product. Another example may relate to sudden or breaking news items corresponding to the enterprise or product. Some social media data may contain bad, or negative, words (e.g. blacklist, concern, ban, . . . , etc.). The previously trained model might tag these verbatims as Negative, but the verbatims may not necessarily have a negative sentiment toward the enterprise. The context of the news item may need to be accounted for when categorizing these posts (e.g., by retraining the sentiment model).

In an embodiment, many weeks of manually tagged data may be used to initially train the NLP models for the desired data sets and topics. In an example, 30-50 weeks of manually tagged data may have been collected and stored as historical data in the database (FIG. 1, 140). Fewer weeks of data may be used in practice, but may show more p-values less than the selected threshold until the NLP model has been adequately trained. Thus, providing more manual tagging at the front end may reduce the amount of time spent in the model retraining feedback loop 325. Trade-offs may be made based on required accuracy, staff availability for tagging, etc.

In an embodiment, m=50 weeks of manual tagging data may be available. At Week 51 (m+1), consolidated data used to calculate the mean for a bucket and a confidence range for the bucket may be fairly accurate, by consolidating the current week (51) with the previous m=50 weeks of data (Weeks 1-50). Even though only a subset of weekly data may be manually tagged each week, accuracy may be improved with many multiple weeks of data. As a practical matter, consolidated data may use m weeks of data, and not be infinitely cumulative. Thus, in an embodiment, only m previous weeks of tagged data need be stored in the database at any given time for validation purposes. In an example, at Week m+2 (e.g., 52), the database may hold 49 weeks of manually tagged data (e.g., Weeks 2-50) and 1 week of automated and NLP model generated tagged data (e.g., from Week 51). At Week m+(m−1) (Week 99), most of the manually tagged data may have been replaced with automatically tagged (NLP model generated) data. For example, the database may hold data from weeks 49-98 where Weeks 49-50 comprise manually tagged data and Weeks 51-98 comprise data generated by the NLP model. As long as the bucket data remain within the pre-defined confidence thresholds, the NLP models may be deemed accurate, and no more manual tagging may be required. In an embodiment, an analytics team may choose to add manually tagged data for model retraining on a periodic basis, especially once all of the original manually tagged data has been aged out of the historic data.

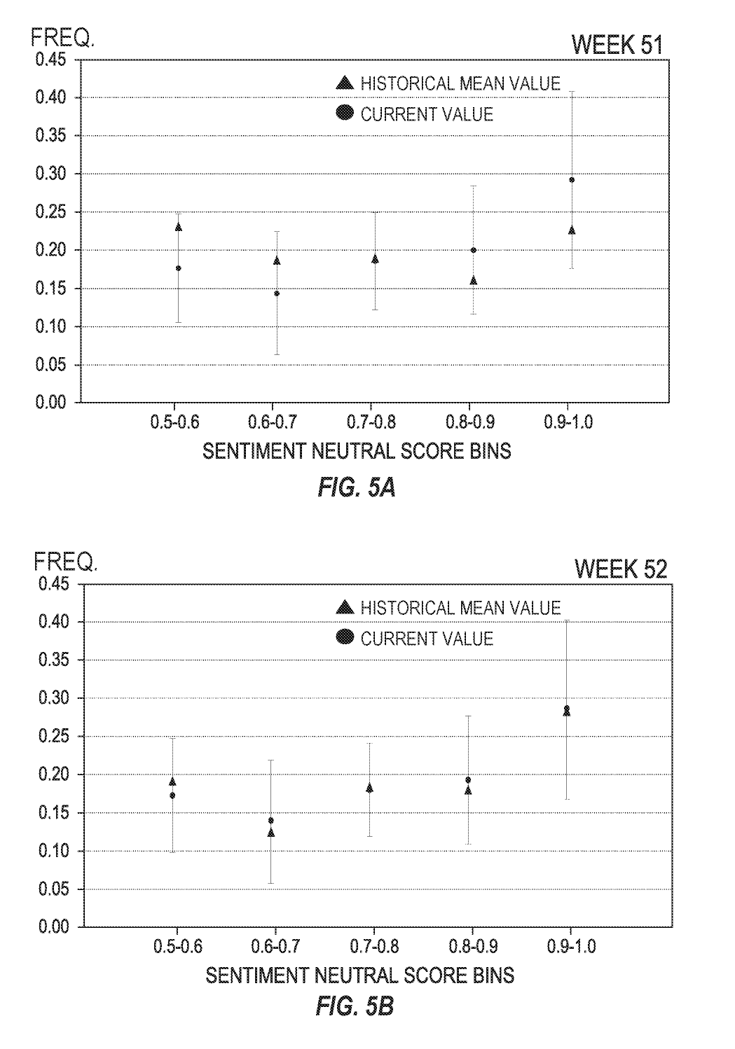

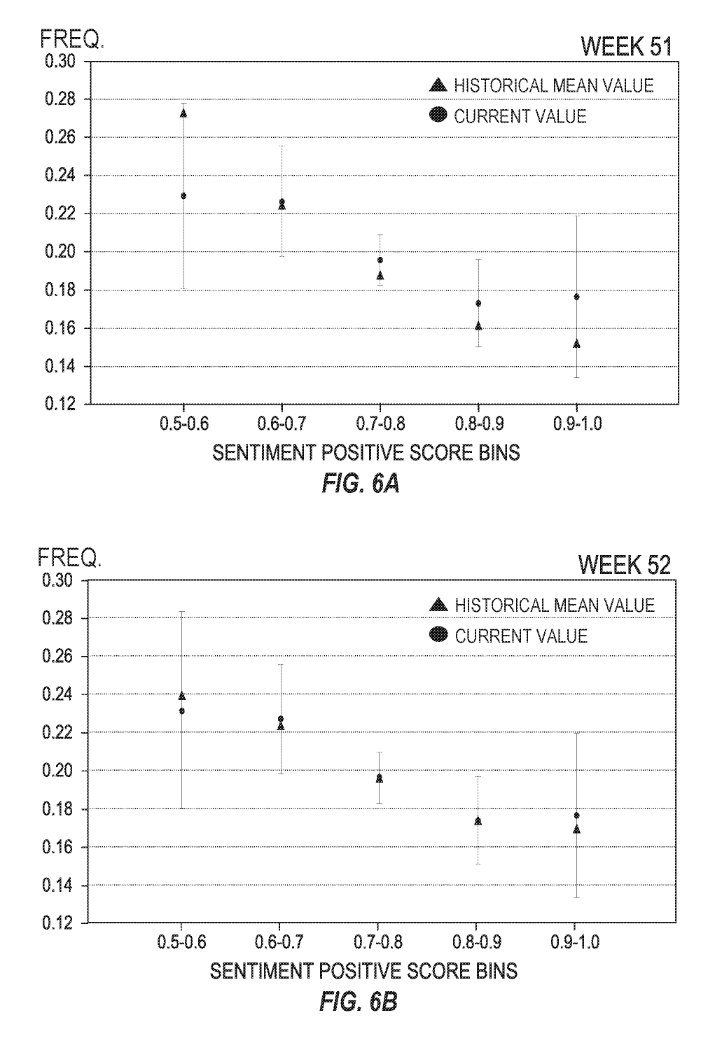

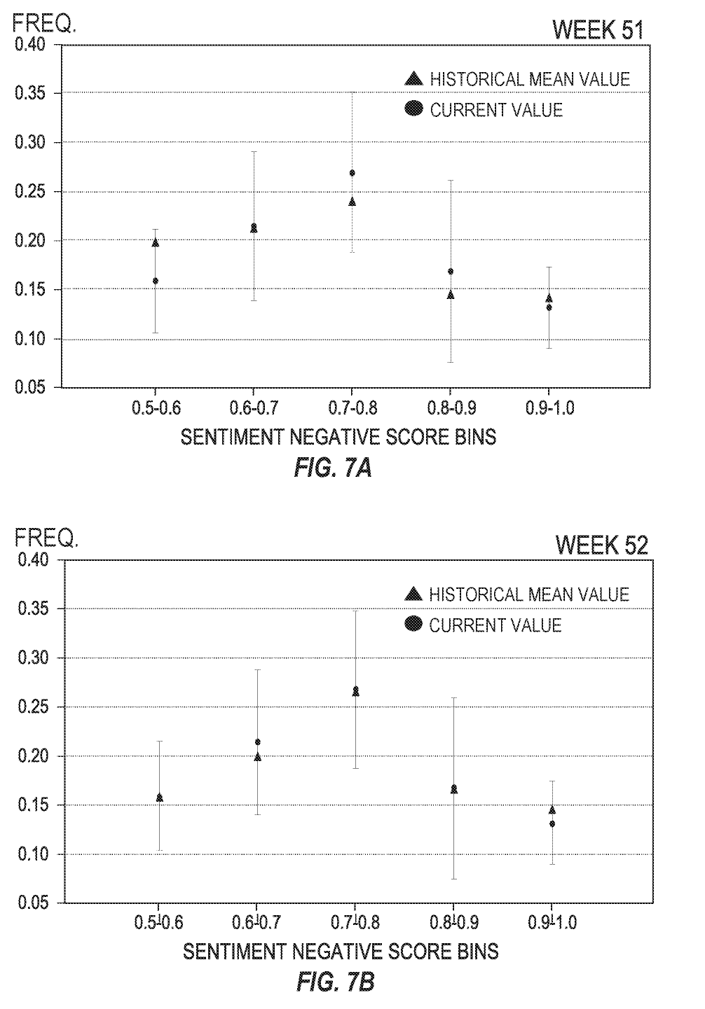

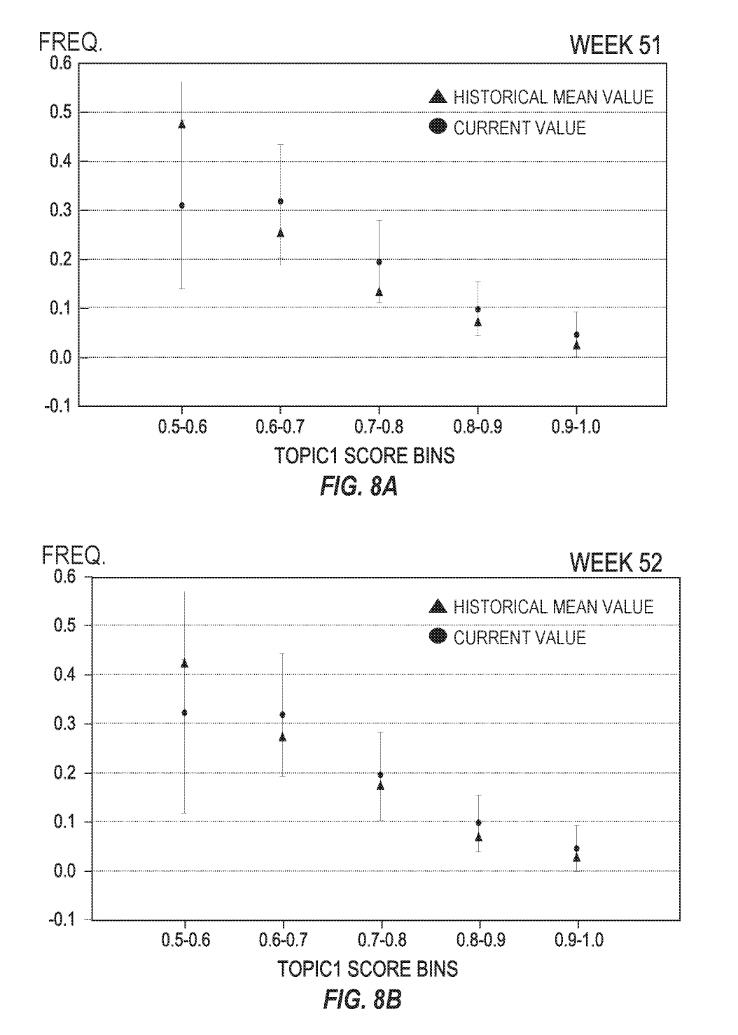

In an embodiment, various NLP models may be used for varying analytics purposes and for different topics or verbatim types. The various consolidated data may be graphed and displayed to a user at block 313. While the graph rendering is shown in block 313, immediately following the p-value calculation, a visual graph may be rendered and displayed to a user at any time after consolidating the data (block 303). In an example, a company or enterprise may define data as relevant only if it mentions the selected company or enterprise. FIGS. 4A-B illustrate graphs at Week 51 and Week 52, respectively, for a relevance model at the company-level. In an embodiment, an analytics team may want to determine sentiment associated with social media posts and tag the posts as sentiment neutral, sentiment positive, or sentiment negative. FIGS. 5A-B illustrate two weeks of data for sentiment neutral scoring. FIGS. 6A-B illustrate two weeks of data for sentiment positive scoring. FIGS. 7A-B illustrate two weeks of data for sentiment negative scoring. FIGS. 8A-B illustrate two weeks of data for scoring of defined Topic1. It will be understood that validation methodology as described herein may be applied to a variety of trainable NLP models, for any number of topics or relevancy factors that may be defined by an analytics team.

It should be noted that the example graphs associated with sentiment and topic analysis only show bins beginning at 0.5-0.6. Relevance analysis may be a binary decision (e.g., relevant vs. not relevant), but because of the nature of sentiment having negative, neutral or positive characteristics for the same text, sentiment analysis may be deemed to be a multi-class category classification. Similarly, topic analysis may not be a binary analysis. For example, for sentiment analysis, a prediction score may be generated for each category. The prediction score is between 0 and 1, and indicates how likely the piece of text belongs to this particular category. Only the highest score across these categories are graphed for the category, because by definition, the lower scores will fall into a different sentiment category. In an embodiment, all bins may be included in the graph, but this is not necessary to provide visual clues as to the success of the models and confidence range of the data.

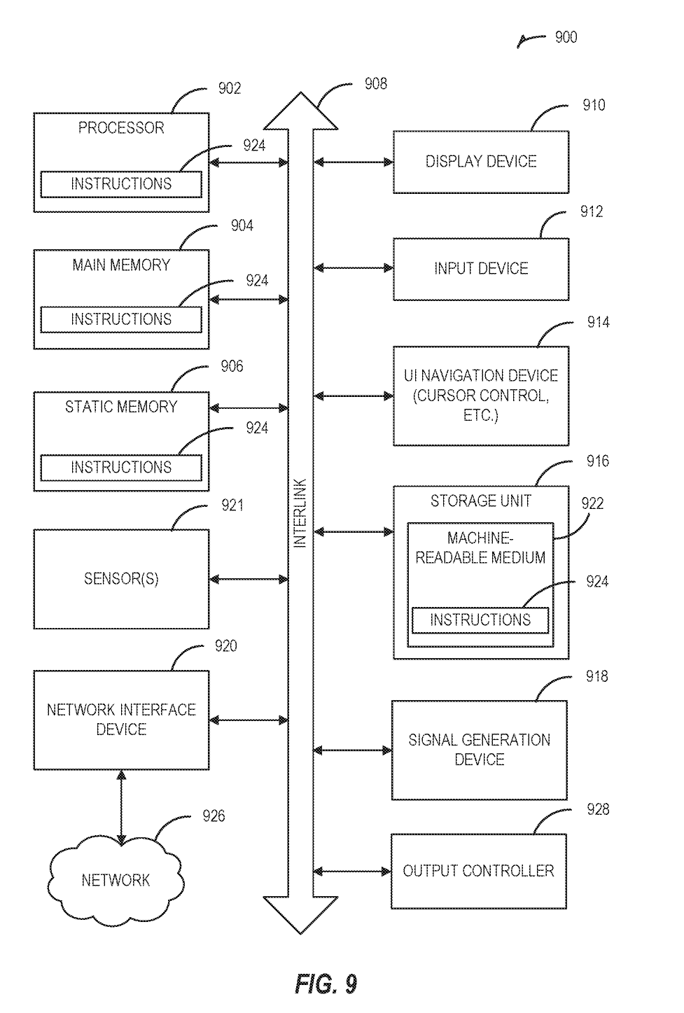

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fit, IEEE 802.16 family of standards known as WiMax®), IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for a confidence validation system according to embodiments and examples described herein.

Example 1 is a confidence validation system, comprising: a processor coupled to a storage medium including instructions stored thereon, the instructions when executed cause a machine to: receive a plurality of unstructured text items for a current time period; analyze each of the plurality of unstructured text items for relevance or contextual classification to tag each of the plurality of unstructured text items with identified relevance or contextual classification, the analyzing to use at least one logic module for natural language processing; generate at least one tagged data set based at least on the analyzing of the plurality unstructured text items; store the at least one tagged data set in an historic database communicatively coupled to the processor; perform automatic analysis of a first tagged data set for the current time period as compared to historical tagged data sets for m number of time periods, the instructions for automatic analysis to include instructions to identify a statistical p-value for the first tagged data set for the current time period as compared to a Gaussian distribution of the m time periods of historical tagged data sets; and determine whether the at least one tagged data set for the current time period falls outside of expected results.

In Example 2, the subject matter of Example 1 optionally includes wherein the instructions to perform automatic analysis of the first tagged data set include instructions to: score each of the unstructured data items in the at least one tagged data set, wherein scoring is based at least on tags applied to the each of the plurality of unstructured text items based on relevance or contextual classification; generate n probability score buckets, where each of the plurality of unstructured text items is to be assigned to one of n probability score buckets based on the tags applied, where the n probability score buckets represent a probability score count distribution for unstructured text items received during the current time period; and consolidate the m time periods of historical tagged data sets; and statistically compare the probability score buckets with the consolidated historical tagged data sets.

In Example 3, the subject matter of Example 2 optionally includes wherein the instructions to perform automatic analysis of the first tagged data set include instructions to: calculate the p-value probability of finding extreme results, wherein when the calculated p-value<0.05, initiate manual tagging of the current time period's unstructured text items.

In Example 4, the subject matter of any one or more of Examples 2-3 optionally include wherein the instructions to perform automatic analysis of the first tagged data set include instructions to: determine whether the current time period data falls within normal ranges or outside of normal ranges, and when the current time period data falls within normal range, then calculate percentages of data within each bucket, and add the current time period data to a reference sample set S, and when current time period data falls outside normal range, then send a notification.

In Example 5, the subject matter of Example 4 optionally includes wherein the instructions to perform automatic analysis of the first tagged data set include instructions to: store the reference sample set S in the historical database as data for time period m+1.

In Example 6, the subject matter of any one or more of Examples 4-5 optionally include wherein the medium further comprises instructions to: responsive to manual tagging for a subset of unstructured text items for the current time period, apply scoring results from the manual tagging to the historical database as the sample set S for the time period m+1.

In Example 7, the subject matter of any one or more of Examples 4-6 optionally include wherein the historical tagged data sets stored in the historical database for an initial m time periods include some manually tagged data sets as a baseline.

In Example 8, the subject matter of any one or more of Examples 1-7 optionally include a display unit coupled to the processor, and wherein when executed, the instructions further cause the machine to: generate a graph representing confidence ranges for a current time period score in each probability score bucket for a relevancy or contextual classification category; and render the graph to the display unit.

In Example 9, the subject matter of any one or more of Examples 4-8 optionally include wherein the historical tagged data sets for an initial k number of time periods comprises manually tagged data sets for all k time periods, and wherein when a reference sample set S for the current time period is added to the historical database, a first reference sample set is omitted from inclusion in the statistically comparing for a time period for a subsequent time period, resulting in the m number of time periods representing the most recent m time periods.

Example 10 is a computer implemented method, comprising: receiving a plurality of unstructured text items for a current time period; analyzing each of the plurality of unstructured text items for relevance or contextual classification to tag each of the plurality of unstructured text items with identified relevance or contextual classification, the analyzing to use at least one logic module for natural language processing; generating at least one tagged data set based at least on the analyzing of the plurality unstructured text items; storing the at least one tagged data set in an historic database; performing automatic analysis of a first tagged data set for the current time period as compared to historical tagged data sets for m number of time periods; identifying a statistical p-value for the first tagged data set for the current time period as compared to a Gaussian distribution of the m time periods of historical tagged data sets; and determining whether the at least one tagged data set for the current time period falls outside of expected results.

In Example 11, the subject matter of Example 10 optionally includes scoring each of the unstructured data items in the at least one tagged data set, wherein scoring is based at least on tags applied to the each of the plurality of unstructured text items based on relevance or contextual classification; generating n probability score buckets, where each of the plurality of unstructured text items is to be assigned to one of n probability score buckets based on the tags applied, where the n probability score buckets represent a probability score count distribution for unstructured text items received during the current time period; consolidating the m time periods of historical tagged data sets; and statistically comparing the probability score buckets with the consolidated historical tagged data sets.

In Example 12, the subject matter of Example 11 optionally includes wherein the performing automatic analysis of the first tagged data set further comprises: calculating the p-value probability of finding extreme results; and when the calculated p-value<0.05, initiating manual tagging of the current time period's unstructured text items.

In Example 13, the subject matter of any one or more of Examples 11-12 optionally include wherein the performing automatic analysis of the first tagged data set further comprises: determining whether the current time period data falls within normal ranges or outside of normal ranges, and when the current time period data falls within normal range, then calculating percentages of data within each bucket, and adding the current time period data to a reference sample set S, and when current time period data falls outside normal range, then sending a notification.

In Example 14, the subject matter of Example 13 optionally includes wherein the performing automatic analysis of the first tagged data set further comprises: storing the reference sample set S in the historical database as data for time period m+1.

In Example 15, the subject matter of any one or more of Examples 13-14 optionally include responsive to manual tagging for a subset of unstructured text items for the current time period, applying scoring results from the manual tagging to the historical database as the sample set S for the time period m+1.

In Example 16, the subject matter of any one or more of Examples 13-15 optionally include wherein the historical tagged data sets stored in the historical database for an initial m time periods include some manually tagged data sets as a baseline.

In Example 17, the subject matter of any one or more of Examples 10-16 optionally include generating a graph representing confidence ranges for a current time period score in each probability score bucket for a relevancy or contextual classification category; and rendering the graph to a display unit.

In Example 18, the subject matter of any one or more of Examples 13-17 optionally include wherein the historical tagged data sets for an initial k number of time periods comprises manually tagged data sets for all k time periods, and wherein when a reference sample set S for the current time period is added to the historical database, a first reference sample set is omitted from inclusion in the statistically comparing for a time period for a subsequent time period, resulting in the m number of time periods representing the most recent m time periods.

Example 19 is a computer readable storage medium having instructions stored thereon, the instructions when executed on a machine cause the machine to: receive a plurality of unstructured text items for a current time period; analyze each of the plurality of unstructured text items for relevance or contextual classification to tag each of the plurality of unstructured text items with identified relevance or contextual classification, the analyzing to use at least one logic module for natural language processing: generate at least one tagged data set based at least on the analyzing of the plurality unstructured text items; store the at least one tagged data set in an historic database; perform automatic analysis of a first tagged data set for the current time period as compared to historical tagged data sets for m number of time periods; identify a statistical p-value for the first tagged data set for the current time period as compared to a Gaussian distribution of the m time periods of historical tagged data sets; and determine whether the at least one tagged data set for the current time period falls outside of expected results.

In Example 20, the subject matter of Example 19 optionally includes instructions to: score each of the unstructured data items in the at least one tagged data set, wherein scoring is based at least on tags applied to the each of the plurality of unstructured text items based on relevance or contextual classification; generate n probability score buckets, where each of the plurality of unstructured text items is to be assigned to one of n probability score buckets based on the tags applied, where the n probability score buckets represent a probability score count distribution for unstructured text items received during the current time period; consolidating the m time periods of historical tagged data sets; and statistically comparing the probability score buckets with the consolidated historical tagged data sets.

Example 21 is a system configured to perform operations of any one or more of Examples 1-20.

Example 22 is a method for performing operations of any one or more of Examples 1-20.

Example 23 is a machine readable medium including instructions that, when executed by a machine cause the machine to perform the operations of any one or more of Examples 1-20.

Example 24 is a system comprising means for performing the operations of any one or more of Examples 1-20

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and in “which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A confidence validation system, comprising:
a processor coupled to a storage medium including instructions stored thereon, the instructions when executed cause a machine to:
receive a plurality of unstructured text items for a current time period;
analyze each of the plurality of unstructured text items for relevance or contextual classification to tag each of the plurality of unstructured text items with identified relevance or contextual classification, the analyzing to use at least one logic module for natural language processing;
generate at least one tagged data set based at least on the analyzing of the plurality unstructured text items;
store the at least one tagged data set in an historic database communicatively coupled to the processor;
perform automatic analysis of a first tagged data set for the current time period as compared to historical tagged data sets for m number of time periods, the instructions for automatic analysis to include instructions to identify a statistical p-value for the first tagged data set for the current time period as compared to a Gaussian distribution of the m time periods of historical tagged data sets; and
determine whether the at least one tagged data set for the current time period falls outside of expected results.

2. The confidence validation system as recited in claim 1, wherein the instructions to perform automatic analysis of the first tagged data set include instructions to:
score each of the unstructured data items in the at least one tagged data set, wherein scoring is based at least on tags applied to the each of the plurality of unstructured text items based on relevance or contextual classification;
generate n probability score buckets, where each of the plurality of unstructured text items is to be assigned to one of n probability score buckets based on the tags applied, where the n probability score buckets represent a probability score count distribution for unstructured text items received during the current time period;
consolidate the m time periods of historical tagged data sets; and
statistically compare the probability score buckets with the consolidated historical tagged data sets.

3. The confidence validation system as recited in claim 2, wherein the instructions to perform automatic analysis of the first tagged data set include instructions to:
calculate the p-value probability of finding extreme results, wherein when the calculated p-value<0.05, initiate manual tagging of the current time period's unstructured text items.

4. The confidence validation system as recited in claim 2, wherein the instructions to perform automatic analysis of the first tagged data set include instructions to:
determine whether the current time period data falls within normal ranges or outside of normal ranges, and
when the current time period data falls within normal range, then calculate percentages of data within each bucket, and add the current time period data to a reference sample set S, and
when current time period data falls outside normal range, then send a notification.

5. The confidence validation system as recited in claim 4, wherein the instructions to perform automatic analysis of the first tagged data set include instructions to:
store the reference sample set S in the historical database as data for time period m+1.

6. The confidence validation system as recited in claim 4, wherein the medium further comprises instructions to:
responsive to manual tagging for a subset of unstructured text items for the current time period, apply scoring results from the manual tagging to the historical database as the sample set S for the time period m+1.

7. The confidence validation system as recited in claim 4, wherein the historical tagged data sets stored in the historical database for an initial m time periods include some manually tagged data sets as a baseline.

8. The confidence validation system as recited in claim 1, further comprising:
a display unit coupled to the processor, and wherein when executed, the instructions further cause the machine to:
generate a graph representing confidence ranges for a current time period score in each probability score bucket for a relevancy or contextual classification category; and
render the graph to the display unit.

9. The confidence validation system as recited in claim 4, wherein the historical tagged data sets for an initial k number of time periods comprises manually tagged data sets for all k time periods, and wherein when a reference sample set S for the current time period is added to the historical database, a first reference sample set is omitted from inclusion in the statistically comparing for a time period for a subsequent time period, resulting in the m number of time periods representing the most recent m time periods.

10. A computer implemented method, comprising:
receiving a plurality of unstructured text items for a current time period;
analyzing each of the plurality of unstructured text items for relevance or contextual classification to tag each of the plurality of unstructured text items with identified relevance or contextual classification, the analyzing to use at least one logic module for natural language processing;
generating at least one tagged data set based at least on the analyzing of the plurality unstructured text items;
storing the at least one tagged data set in an historic database;
performing automatic analysis of a first tagged data set for the current time period as compared to historical tagged data sets for m number of time periods;
identifying a statistical p-value for the first tagged data set for the current time period as compared to a Gaussian distribution of the m time periods of historical tagged data sets; and
determining whether the at least one tagged data set for the current time period falls outside of expected results.

11. The computer implemented method as recited in claim 10, further comprising:
scoring each of the unstructured data items in the at least one tagged data set, wherein scoring is based at least on tags applied to the each of the plurality of unstructured text items based on relevance or contextual classification;
generating n probability score buckets, where each of the plurality of unstructured text items is to be assigned to one of n probability score buckets based on the tags applied, where the n probability score buckets represent a probability score count distribution for unstructured text items received during the current time period;
consolidating the m time periods of historical tagged data sets; and
statistically comparing the probability score buckets with the consolidated historical tagged data sets.

12. The computer implemented method as recited in claim 11, wherein the performing automatic analysis of the first tagged data set further comprises:
calculating the p-value probability of finding extreme results; and
when the calculated p-value<0.05, initiating manual tagging of the current time period's unstructured text items.

13. The computer implemented method as recited in claim 11, wherein the performing automatic analysis of the first tagged data set further comprises:
determining whether the current time period data falls within normal ranges or outside of normal ranges, and
when the current time period data falls within normal range, then calculating percentages of data within each bucket, and adding the current time period data to a reference sample set S, and
when current time period data falls outside normal range, then sending a notification.

14. The computer implemented method as recited in claim 13, wherein the performing automatic analysis of the first tagged data set further comprises:
storing the reference sample set S in the historical database as data for time period m+1.

15. The computer implemented method as recited in claim 13, further comprising:
responsive to manual tagging for a subset of unstructured text items for the current time period, applying scoring results from the manual tagging to the historical database as the sample set S for the time period m+1.

16. The computer implemented method as recited in claim 13, wherein the historical tagged data sets stored in the historical database for an initial m time periods include some manually tagged data sets as a baseline.

17. The computer implemented method as recited in claim 10, further comprising:
generating a graph representing confidence ranges for a current time period score in each probability score bucket for a relevancy or contextual classification category; and
rendering the graph to a display unit.

18. The computer implemented method as recited in claim 13, wherein the historical tagged data sets for an initial k number of time periods comprises manually tagged data sets for all k time periods, and wherein when a reference sample set S for the current time period is added to the historical database, a first reference sample set is omitted from inclusion in the statistically comparing for a time period for a subsequent time period, resulting in the m number of time periods representing the most recent m time periods.

19. A computer readable storage medium having instructions stored thereon, the instructions when executed on a machine cause the machine to:
receive a plurality of unstructured text items for a current time period;
analyze each of the plurality of unstructured text items for relevance or contextual classification to tag each of the plurality of unstructured text items with identified relevance or contextual classification, the analyzing to use at least one logic module for natural language processing;
generate at least one tagged data set based at least on the analyzing of the plurality unstructured text items;
store the at least one tagged data set in an historic database;
perform automatic analysis of a first tagged data set for the current time period as compared to historical tagged data sets for m number of time periods;
identify a statistical p-value for the first tagged data set for the current time period as compared to a Gaussian distribution of the m time periods of historical tagged data sets; and
determine whether the at least one tagged data set for the current time period falls outside of expected results.

20. The computer readable storage medium as recited in claim 19, further comprising instructions to:
score each of the unstructured data items in the at least one tagged data set, wherein scoring is based at least on tags applied to the each of the plurality of unstructured text items based on relevance or contextual classification;
generate n probability score buckets, where each of the plurality of unstructured text items is to be assigned to one of n probability score buckets based on the tags applied, where the n probability score buckets represent a probability score count distribution for unstructured text items received during the current time period;
consolidating the m time periods of historical tagged data sets; and
statistically comparing the probability score buckets with the consolidated historical tagged data sets.
